(19) United States
(12) Patent Application Publication
(10) Pub. No.: US 2002/0081341 A1
(43) Pub. Date: Jun. 27, 2002

(54) Method, apparatus, and system for customizing essential oil formulations

(76) Inventor: Cheryl Sott, Jamesport, NY (US)

Correspondence Address: Wyatt, Gerber & O'Rourke, 99 Park Avenue, New York, NY, 10016, US

(21) Appl. No.: 09/943,372

(22) Filed: Aug. 30, 2001

Related U.S. Application Data
(60) Provisional application No. 60/229,154, filed on Aug. 31, 2000.

(51) Int. Cl. A61K 35/78; G06F 19/00; G01N 33/48; G01N 33/50

(52) U.S. Cl. 424/725; 702/19

(57) ABSTRACT

The present invention is directed to a method system and apparatus for formulating an essential oil based composition. In formulating the composition an analysis of an individual is performed. From the analysis a value is calculated which determines whether one or more essential oils may be excluded from an essential oil universe comprising a plurality of essential oils to form an active essential oil universe. A sub-set of the essential oil universe is generated that contains only oils associated with the given value. A primary essential oil from the sub-set based on the analysis; and a primary essential oil family set is generated. A second essential oil and any subsequent oils is generated from the primary essential oil family set, based on the analysis. These steps for selecting the second essential oil may be repeated for any additional essential oils to be selected.

This application claims priority on Provisional Application Serial No. 60/229,154 filed Aug. 31, 2002.

### FIELD OF THE INVENTION

The present invention is directed to improvements in the treatment of persons by aromatherapy, improved essential oil formulations, improved methods of making the formulations and products using the formulations.

### BACKGROUND OF THE INVENTION

Aromatherapy in one form or another has been around and has been practiced in one form or another since at least the dawn of civilization. One school of thought traces aromatherapy to ancient Egypt. A medical papyri has been found that is believed to date back to around 1550 BC which contains remedies for a number of illnesses and the methods of application are not unlike some of the ones used in aromatherapy today. The Egyptians used a method known as infusion to extract the oils from aromatic plants and incense is an example of one of the earliest ways of using aromatics. Frankincense was burned at sun rise as an offering to the sun god, Ra and myrrh was offered to the moon. The Egyptians used aromatics in embalming to help preserve flesh. The Egyptians also used fragrant oils after bathing either alone or accompanied by a massage. There is a strong possibility that the ancient Chinese civilizations were using some form of aromatics at the same time as the Egyptians. Shen Nung's Herbal book is the oldest surviving medical book in China which is dated about 2700 B.C. and contains information on over 300 plants. The ancient Greeks also used aromatic oils both medicinally and cosmetically.

Aromatherapy may be defined as the art, and science, of using oils extracted from aromatic plants to enhance health, beauty and overall wellness of an individual. These oils are known as essential oils. Apart from the physical benefits, it is believed that the essential oils can have subtle effects on the mind and emotions. The essential oils taken from plants and used in aromatherapy are not only substances which gives the plants their scent but are considered by some to be the plant's “life force” i.e., they are essential to the plants' biological process. The essential oils used in aromatherapy are extracted from flowers; herbs; spices; woods and fibers, usually by distillation, expression and solvent extraction. Essential oils may be very expensive to produce, some more so than others, due to the labor intensive process and the quantity of the plant required to produce the oil, Approximately 400 kg of thyme would produce 1 kg of essential oil, 2000 kg of rose petals to make 1 kg of oil, 6 tons of orange blossom to produce 1 kg of neroli, and 4 million jasmine flowers to produce 1 kg of jasmine absolute. Essential oils have also been known as fragrance oils and are used in the fragrance industry, in their natural or synthetic form. Essential oils, contrary to the use of the word “oil” may not be really oily-feeling at all, rather, essential oil largely refers to the volatile component of plant material.

Aromatherapy uses the essential oils in a variety of ways. One way is in a massage. Some people consider the use of the oils in a massage to be the most effective method of using the oils, because the message combines their oils properties with the therapeutic power of touch. The oils are usually not used undiluted, but are frequently combined with an odorless carrier oil, which may include, such oils as grapeseed, sweet almond or peach kernel. The diluted solution may be about 3% essential oil. Some essential oil constituent chemicals may be absorbed through the skin in small amounts but is believed that the amount is of therapeutic value. Essential oils that are drawn into the body by the sense smell are believed to offer psychological and physical benefits; not only does the aroma of the true plant stimulate the brain to trigger a positive effect, but the natural components of the essential oil are drawn into the lungs and can also supply physical benefits also. Careful inhalation of the oils can also provide therapeutic benefit as the oil molecules enter the lungs and are absorbed into the bloodstream. If not done correctly and safely, however, the use of essential oils may also have negative consequences, in some circumstances. The components of the various oils are believed to aid in a variety of health, beauty and hygiene conditions. Essential oils can supply other benefits as well. Some oils, for instance, act as a natural repellent and pesticide. Essential oils may be blended together to provide an especially pleasing fragrance and are also used to aid in providing a specific health benefit. A synergistic essential oil blend of the correct oils in proper proportions is considered to be greater in total benefit than each oil working independently.

One aspect of the application of essential oils and aromatherapy relates to treatment of the body's Chakras. The word chakra is a Sanskrit word meaning wheel or disk. Described as a wheel-like spinning vortex, a chakra is a point of intersection between various planes. The seven major centers along the spinal column have the greatest significance and the highest number of correlations in the treatment of chakras. These seven centers are thought of as the master chakras. Chakras are also called lotuses, symbolizing the unfolding of flower petals which metaphorically describe the opening of a chakra. Like flowers, chakras are believed to be opened or closed, dying or budding, depending on the consciousness within. Chakras are associated with seven basic levels of consciousness. The seven master chakra centers are identified as;

Chakra one, located at the base of the spine, is associated with survival. Its element is earth.

Chakra two, located in the lower abdomen is associated with emotions and sexuality. Its element is water.

Chakra three, located in the solar plexus, is associated with personal power and metabolic energy. Its element is fire.

Chakra four, located over the sternum, is associated with love. Its element is air.

Chakra five, located in the throat, is associated with communication and creativity. Its element is sound.

Chakra six, located in the center of the forehead, is associated with clairvoyance intuition and imagination. Its element is light.

Chakra seven, located at the top of the head, is associated with knowledge and understanding. Its element is thought.

Various formulations are designed to address the treatment by aromatherapy of the various Chakras in a user.

Recently, consimers have become more and more aware of the benefits certain fragrancing components offer and in particular the benefits achieved by using essential oils. Manufacturers such as Aveda and Estee Lauder provide consumers with a range of essential oil based aromatherapy related products. Unfortunately, mass marketed formulations are limited to only a few targeted benefits and these are for the most part stress relief oriented. Aromatherapy or essential oil blends are highly personal and the formulations can vary for each individual. The cost to a manufacturer to produce products in infinite combinations to address the needs of each individual consumer would be prohibitive. Even if manufacturers were willing to produce a broad spectrum of targeted formulations, retailers would not necessarily be willing to inventory a full range of products because of the risk of loss on poorly selling items and the lack of retail shelf space to carry a full range of formulations.

Another issue with respect to producing the necessary wide variety of formulations is the required knowledge of each essential oil, its benefits, its fragrant qualities alone and in combination with other essential oils and how each of these oils and their combinations may be more or less of a benefit to a particular individual.

### OBJECTS OF THE INVENTION

It is an object of the invention to provide an improved method of determining essential oil formulations.

It is an object of the present invention to provide an improved system of determining essential oil formulations.

It is also an object of the present invention to provide an improved apparatus for determining essential oil formulations.

It is a further object of the present invention to provide aromatherapists and others using essential oil formulations with an improved method, system and apparatus for custom formulating essential oil based formulations.

It is a still further object of the present invention to provide aromatherapists and others using essential oil formulation with an improved method, system and apparatus for custom formulatings of essential oil based products.

It is another object of the present invention to provide aromatherapists and others using essential oil formulations with an improved method, system and apparatus for custom formulating essential oil based treatments.

It is also an object of the invention to provide custom formulations of essential oil, aromatherapy based products at a low cost with minimal inventory requirements.

It is another object of the invention to provide a method system and apparatus to permit persons with minimal training to prepare custom formulations of essential oil, aromatherapy based products.

It is another object of the invention to provide a method system and apparatus to prepare custom formulations of essential oil, aromatherapy based products at the point of sale or at a remote location.

### SUMMARY OF THE INVENTION

The present invention is directed to a method of formulating customized aromatherapy, essential oil mixtures. The method includes the steps of obtaining personality and preference information. This information is entered into the system. Based on the information provided personality responses are calculated to determine a personality value. From the personality value one or more essential oils may be excluded from Essential Oil Universe or Modified Essential Oil Universe, in view of certain conditions in the personality value and/or by name. Exclusionary conditions are obtained from the input of consumer information. If so indicated, certain essential oils, from Essential Oil Universe or Modified Essential Oil Universe, that represent adversity to that condition are excluded from the determination. If no oils or additional oils are to be excluded, the process proceeds. The identity of any additional exclusionary oil names, are obtained from input. If the presence of the oil is indicated, then any oil with that name from Essential Oil Universe or Modified Essential Oil Universe. is excluded. The remaining essential oils make up the Active Essential Oil Universe, and this universe is filtered for all oils for the given Personality Value. A Personality Sub-Set is created from step, and contains only oils associated with the given Personality Value.

Based on the input a primary preference is determined. The Personality Sub-Set is searched to satisfy the primary preference according to the ranking and an oil is selected. This oil is added to formulation and used to continue the process. The Essential Oil Personality Sub-Set is searched for all oils that are related to the primary oil selected, to create the Primary Essential Oil Family Set. A secondary preference is also obtained from input. The Primary Essential Oil Family Set is searched to satisfy the secondary preference according to ranking and a second essential oil is selected.

The second selected oil is tested for exactness in name and fragrant “note” to other essential oil(s) that have previously been selected. If the second essential oil is not the same, that oil is confirmed, and placed in formulation. If the oil is the same, that oil is removed from Primary Essential Oil Family Set and then the process repeats itself at starting at the above steps, and for all subsequent preferences selected.

A formulation is created based on selected confirmed essential oil(s).

### BRIEF DESCRIPTION OF THE DRAWINGS

FIG. 1 is a flow chart of the method of the preferred embodiment of the present invention for preparing a customized essential oil formula.

FIG. 1A is flow chart of the core process of the present invention.

FIG. 2 is a flow chart of the essential oil universe modification process of the present invention.

FIG. 3 is a flow chart of the essential oil exclusions process of the present invention.

FIG. 4 is a flow chart of the “Chakra” essential oil selection process of the present invention.

FIG. 5 is a flow chart of the oil selection test process of the present invention.

### DETAILED DESCRIPTION OF THE INVENTION

The system that can be utilized for the generation of essential oil formulations in accordance with one embodiment of the present invention can include a database containing data of essential oils. Such a database can be expressed in electronic media. There is also data received from the client. The data from the client is imported into CPU, which may, for example, comprise a central data processor with an associated system memory and standard peripherals. The CPU also has selectively addressable memory capable of storing digital data. The CPU may also be a network of computers linked together in a wide area network (WAN) or a local area network (LAN), combinations thereof, or one or more independent workstations. At the CPU, the data provided by the client is read and used with the database of essential oil data.

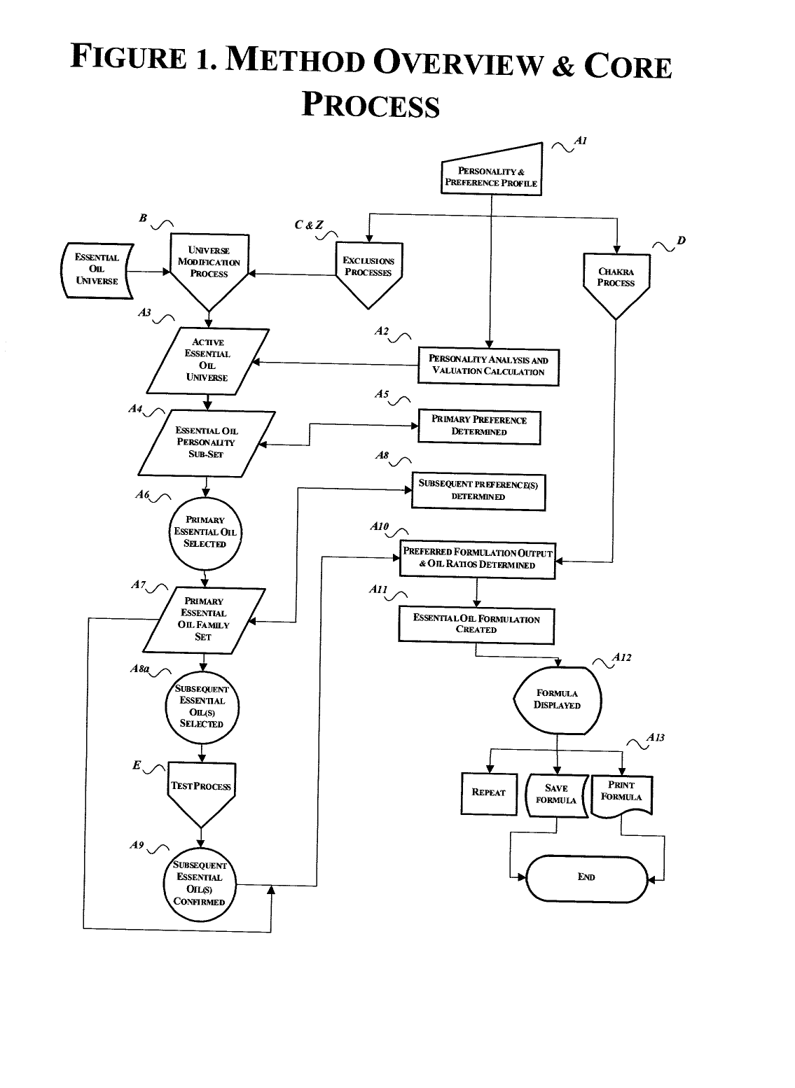

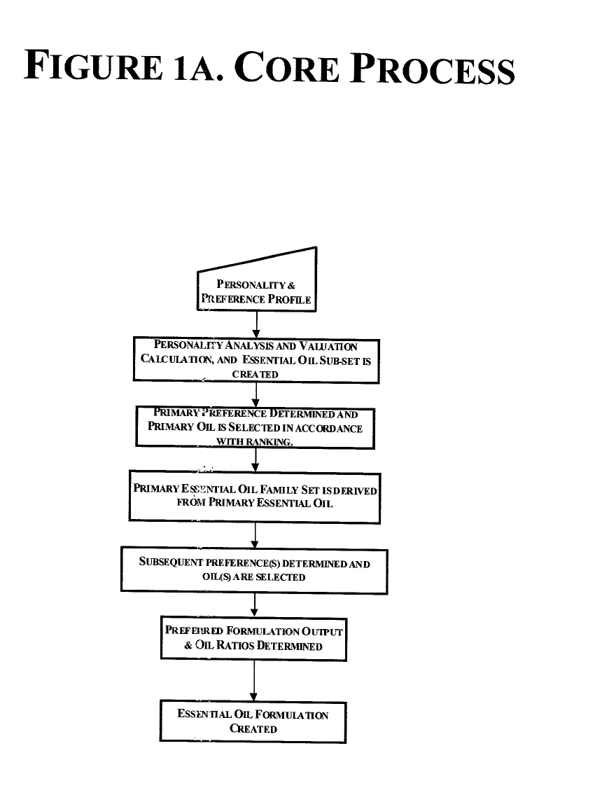

In generating an essential oil formulation, as shown in FIG. 1 the data concerning the customer is obtained from the customer. This data may be entered onto a form and then transferred to the system or the customer data may be directly entered into the system. The data A1 is preferably answers to personality and preference questions. Table A shows representative questions that may be asked of an intended user of the essential oils. Personality responses are calculated to determine a Personality Value A2. From the Personality Value an Essential Oil Subset A4 is created from the active essential oil universe A3. From the Essential Oil Subset A4 a primary essential oil is selected in accordance with primary preference determination A5 and ranking. A related essential oil family set A7 is derived from the primary essential oil and, if indicated, a secondary preference A8 may be determined therefrom and a second essential oil is thus selected.

If additional preference(s) are determined, the tertiary preference is determined and a third essential oil is selected A9. Additional essential oils may be determined in the same manner if desired. Once the identity or identities of the essential oil or oils has been determined, a preferred formulation output A1 and oil ratios are determined. Once the oil ratios are determined, the essential oil formulation A11 is created. The formulation may be displayed A12 on a screen or printed out, etc. Once an essential oil formulation is created, the formulation may be analyzed and a decision made A13 to either repeat the process to come up with a new formulation, or save the formulation and/or if desired to print the formulation.

The formulation will contain one or more essential oils and can be used either by itself as a fragrance or it may be combined with one or more base materials and be used as a massage oil, lotion, salve, unguent, etc. The oils may also be included in a cosmetic formulation, bath or body oil, face cream, hand lotion etc., depending on the user's choice.

As seen in FIG. 1A, in a preferred embodiment a Personality & Preference Profile 1A is generated for a user. A Personality Analysis and Evaluation Calculation A2 is made and from that an essential oil subset is obtained. From the essential oil subset a primary preference A5 is determined and an oil A6 is selected in accordance with the ranking so obtained. From the primary essential oil A6 a related essential family oil set A7 is generated. A secondary preference A8 may be determined and from that a second essential oil is selected A8a. A tertiary preference and subsequent essential oils may be selected in the same manner. Based on the information so obtained a preferred formulation output is obtained and oil ratios are determined A10. Once the oil ratios are determined an essential oil formulation A11 may be created using the information so generated.

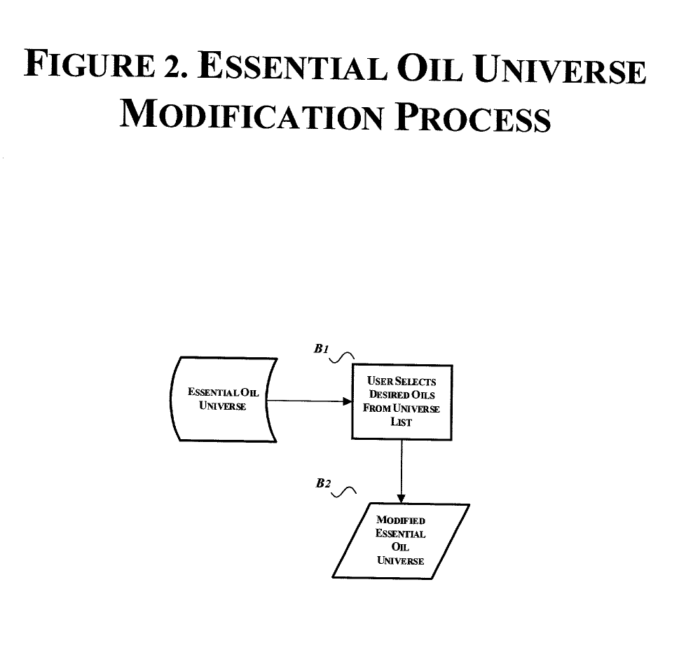

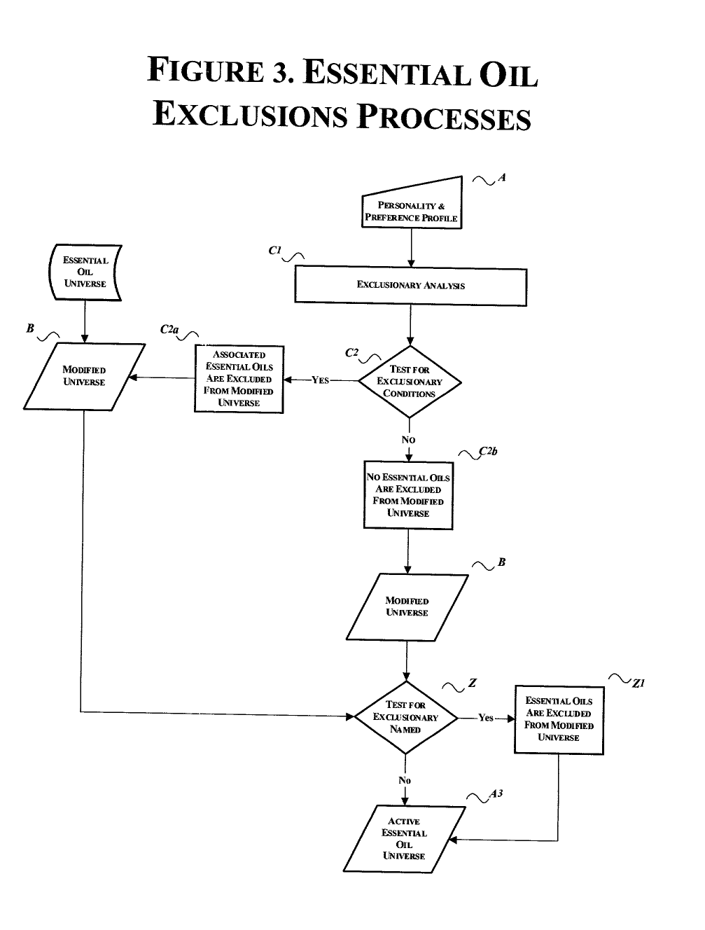

FIG. 2 shows a flow chart where there is the essential oil universe. The universe may be modified B1 by a user selecting or deselecting a desired oil or oils from the universe. The remaining essential oil universe is the modified essential oil universe B2. From time to time there may be a need to eliminate one or more oils from the essential oil universe as shown in FIG. 3. In this embodiment, the personality & preference profile A1 undergoes an exclusionary analysis C1 with the profile being tested C2 for exclusionary conditions such as allergies, among others. If there are no exclusionary conditions, no essential oils are excluded from the essential oil universe, so that the modified universe C2b is actually not modified and becomes active A3. If there are exclusionary conditions present, the essential oil universe may have additional essential oils excluded C2a forming a modified universe. The modified universe, excluding such oils so formed becomes the active essential oil universe A3. It is additionally possible that essential oils may be excluded by name Z, obtained from input. If indicated the oils identified by name are excluded from the modified universe Z1, forming the active universe. If no oils are indicated by name, no essential oils are excluded from the modified universe and thus becomes the active essential oil universe A3.

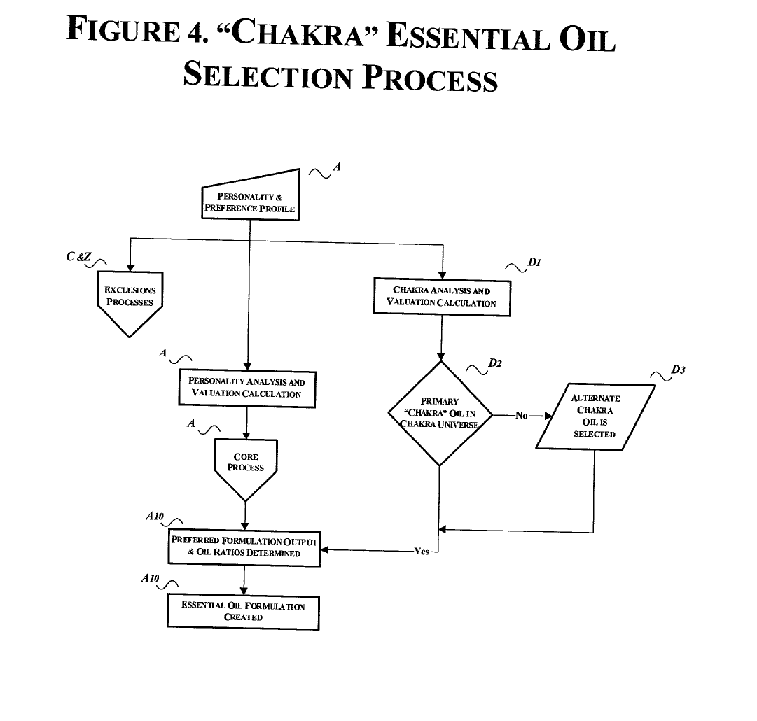

FIG. 4 depicts the “Chaka” essential oil selection process of the present invention. As shown in this Figure, once the personality & Preference Profile is created the exclusionary analysis is performed as is a Chaka Analysis and Valuation Calculation D1 may also be performed. In the Chaka Analysis and Valuation Calculation D1. From this calculation a Primary “Chakra” Oil in the Chakra Universe is obtained and the Active Essential Oil Universe is searched to confirm the active status of th Chakra oil selected. If the Chakra oil is not active an alternative oil is selected.

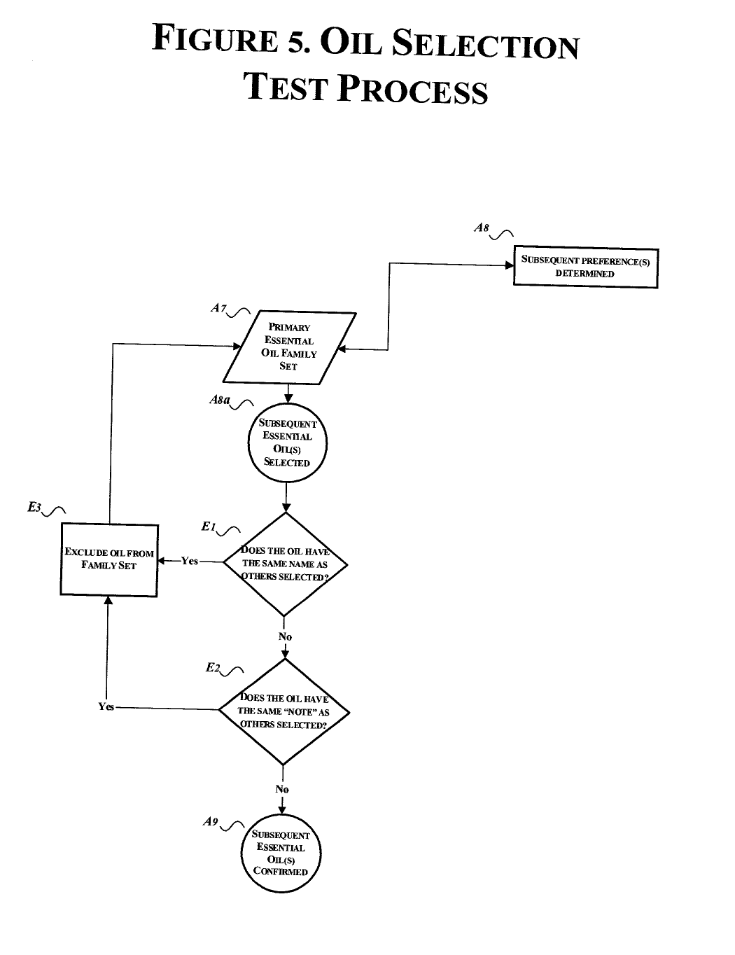

FIG. 5 shows the oil selection test process noted above. In this process an oil that has been selected A8a from the primary essential oil family set A7 is tested. A determination is made E1 whether the oil has the same name as any of the other oil(s) selected and confirmed. If so, that oil is excluded from the Family set. If the oil does not have the same name as the other oils selected and confirmed a further analysis may be made to ascertain whether the oil has the same “Note” as the others selected and confirmed. If so, that oil is excluded from the Family Set. If not, then the oil is selected and confirmed and the process continues by selecting any additional essential oils if desired.

When a user wishes to receive a customized essential oil formulation a series of questions similar to the questions shown in Table A are asked. The results from the questionnaire are inputted into the system. In a preferred embodiment the personality profile responses are given a value which may be a numerical designation and where a numerical designation, the value can either be a single number or a range. Based on the personality profile a first cut of the essential oils is made (primary essential oil set). After a first cut is made by the system two other pieces of information are taken into consideration. These are the focus condition and the actual condition in the focus condition group that are chosen by the user. Based on the actual condition in the focus condition group. The first or primary essential oil is selected. Although in this embodiment the personality profile has been done first and the focus condition second, it will be appreciated by those skilled in the art that the order can be reversed. In addition, while Table A has certain categories presented and items in each category additional categories and items in each category can be added or removed as necessary.

In a preferred embodiment, whatever primary oil is selected for the user's condition that oil generally determines what oils are chosen subsequently. It is desired that all further essential oil selections be preferably compatible with the key primary oil. That primary oil selection will give a subset of one or more oils. The second and third, or a number of subsequent oils are selected from the primary essential oil subset known as the primary essential oil family set. The second oil is selected, determined from the additional chosen conditions and the questionnaire response to the questions relating to that condition. Other focus conditions or health, emotional or spiritual conditions could also be added or subdivided further or even deleted. Based on the responses to the conditions one or more oils will be selected from the primary essential oil family set. In one embodiment, oils selected subsequent to the primary essential oil are tested to determine if they are identical to the primary oil and if so that oil is not accepted and a another is selected in its place.

Question 6 in the Personality Profile may be used where the treatment of Chakra's is desired. The response to this question identifies the Chakra that is to be treated. The Chakra oil or oils are selected by the system and the user may receive an essential oil formulation to treat just the Charka or the user may also answer the remaining questions and receive a formulation as described above that may be combined with the essential oil or oils in the Chakra formulation. Where the Chakra oil is the same as one of the primary, secondary, tertiary or other oils, the Chakra essential oil is added to the formulation unlike the situation described above.

Essential Oils in the Essential Oil Universe may include but are not limited to any one of the following natural or synthetic oils identified by their common or botanical names or variations of those names and blends thereof:

Ajowan—Trachyspermum Ammi,

Amber—Pinus Succinifera

Amyris—Amyris Balsamifera,

Angelica Root European—Angelica Archangelica,

Angelica Seed European—Angelica Archangelica,

Basil—Ocimum Basilicum,

Basil—Ocimum Basilicum,

Basil Linalool—Ocimum Basilicum,

Bay—Pimenta Racemosa,

Benzoin Tincture—Styrax Benzoin Tincture,

Bergamot—Citrus Bergamia,

Bergamot FCF—Citrus Bergamia,

Black Pepper—Piper Nigrum,

Buchu—Barosma Betulina Nigrum,

Cade—Juniperus Oxycedrus,

Cajeput—Melaluca Cajeputi,

Camphor—Cinnamomum Camphora,

Caraway—Carum Carvi,

Cardamom—Elletaria Cardamomum,

Carrot Seed—Daucus Carota,

Cassia—Cinnamomum Cassia,

Catnip—Nepeta Cataria,

Cedarwood Oils

Cedarwood Atlas—Cedrus Atlantica,

Cedarwood Himalayan—Cedrus Deodora,

Cedarwood Texan—Juniperus Texas,

Cedarwood Virginian—Juniperus Virigniana,

Celery Seed—Apium Graveolens,

Chamomile German/Blue—Chamomilla Recutica,

Chamomile Maroc—Ormensis Multicaulis,

Chamomile Roman—Anthemis Nobilis,

Cinnamon Bark—Cinnamomum Zeylanicum,

Cinnamon Leaf—Cinnamomum Zeylanicum,

Citronella—Cymbopogon Nardus,

Clary Sage—Salvia Sclarea,

Clove Bud—Eugenia Caryophyllata,

Copibia—Balsam

Coriander—Coriandrum Sativum,

Cubeb—Piper Cubeba,

Cumin Seed—Cuminum Cyminum,

Black Cumin Seed—Nigella Sativa,

Cypress—Cupressus Sempervirens,

Davana—Artemisia Pallens,

Dill Seed—Anethum Graveolens,

Elemi—Canarium Luzonicum,

Eucalyptus—Eucalyptus Globulus,

Eucalyptus Dives—Eucalyptus Dives,

Eucalyptus Lemon—Eucalyptus Citriodora,

Eucalyptus Polybractea—Eucalyptus Polybractea,

Eucalyptus Radiata—Eucalyptus Radiata,

Eucalyptus Smithii—Eucalyptus Smithii,

Eucalyptus Staigeriana—Eucalyptus Staigeriana,

Fennel, Sweet—Foeniculum Vulgare,

Fir Needle—Abies Sibirica,

Frankincense Oils

Frankincense Carteri—Boswellia Carteri,

Frankincense Thurifera—Boswellia Thurifera,

Galangal—Galangal Officinalis,

Galbanum—Ferula Galbaniffiua,

Geranium Oils

Geranium Bourbon—Pelargonium Roseum,

Geranium China—Pelargonium Graveolens,

Geranium Egypt—Pelargonium Graveolens,

Ginger—Zingiber Officinale,

Gingergrass—Cymbopogon Martini (Sofia),

Grapefruit—Citrus Paradisi,

Ho Leaf—Cinnamomum Camphora,

Hyssop—Hyssopus Officinalis,

Inmortelle (Helichrysum)—Helichrysum Angustifolium,

Juniper Berry—Juniperus Communis,

Juniper Needle—Juniperus Communis,

Kanuka—Leptospermum Ericoides,

Labdanum—Cistus Ladaniferus,

Laurel—Laurus Nobilis,

Lavandin—Lavandula x Hybrida,

Lavender—Lavandula Angustifolia,

Lavender High Alpine—Lavandula Angustifolia,

Lemon—Citrus Limonum,

Lemon Verbena—Lippia Citriodora,

Lemongrass—Cymbopogon Nardus,

Lime (Distilled)—Citrus Aurantifolia,

Linaloe Wood—Bursera Delpechina,

Litsea Cubeba (May Chang)—Litsea Cubeba,

Lovage—Levisticum Officinale,

Mandarin—Citrus Reticulata,

Manuka—Leptospermum Scoparium,

Marjoram—Origanum Marjorana,

Melissa (Blend)—Natural Composite,

Myrrh—Commiphora Myrrha,

Myrtle—Myrtus Communis,

Neroli—Citrus Aurantium v Amara,

Neroli Composite—Natural Composite,

Niaouli—Melalueca Quinquenervia,

Nutmeg—Myristica Fragrans,

Orange—Citrus Aurantium v dulcis,

Orange, Organic—Citrus Aurantium v dulcis,

Orange, Bitter—Citrus Aurantium v Amara,

Origanum—Origanum Vulgare,

Palmarosa—Cymbopogon Martinii,

Parsley Seed—Petroselinum Sativum,

Patchouli—Pogostemon Cablin,

Peppermint—Mentha Piperita,

Petitgrain—Citrus Aurantium,

Petitgrain Lemon—Citrus Limonum,

Petitgrain Mandarin—Citrus Reticulata,

Pimento Berry—Pimenta Officinalis,

Pimento Leaf—Pimenta Officinalis,

Pine—Pinus Sylvestris,

Ravensara (Organic)—Ravensara Aromatica,

Rose & Geranium—Blend,

Rose Otto—Rosa Damascena,

Rosemary—Rosmarinus Officinalis,

Rosewood—Ocotea Caudata,

Sage Spanish—Salvia Lavandulaefolia,

Sandalwood India—Santalum Album,

Sandalwood Indonesian—Santalum Album,

Savoury—Satureja Hortensis,

Silver Fir Needle—Abies Alba,

Spearmint—Mentha Viridis,

Spike Lavender—Lavandula Latifolia,

Spikenard—Nardostachys Jatamansi,

Star Anise—Illicium Verum,

Tagetes—Tagetes Minuta,

Tangerine—Citrus Reticulata,

Tarragon—Artemisia Dracunculus,

Tea Tree—Melaleuca Altemifolia,

Tea Tree Lemon—Leptospermium Petersonii,

Thyme—Thymus Serpyllum,

Thyme Wild—Thymus Vulgaris,

Thyme, Lemon—Thymus x Citriodorus,

Thyme, Spanish Red—Thymus Vulgaris,

Turmeric—Curcuma Longa,

Valerian Root—Valeriana Officinalis,

Vetivert—Vetivera Zizanoides,

White Birch—Betula Alba,

Yarrow—Achillea Millefolium,

Ylang Ylang Complete Organic—Cananga Odorata v Genuina,

Ylang Ylang Extra—Cananga Odorata v Genuina,

Ylang Ylang Extra (Organic)—Cananga Odorata v Genuina,

Ylang Ylang Extra Superior—Cananga Odorata v Genuina,

Ylang Ylang I—Cananga Odorata v Genuina,

Ylang Ylang II—Cananga Odorata v Genuina,

Ylang Ylang III—Cananga Odorata v Genuina,

Absolute Oils

Ambrette Seed

Hibiscus Abelmoschus

Broom—Spartium Junceum

Calendula—Calendula Officinalis

Carnation—Dianthus Caryophyllus

Cassie—Acacia Farnesiana

Champaca—Michelia Champaca

Elder—Sambucus Nigra

Everlasting—Helichrysum augustifolia

Frangipani—Plumeria Rubra

Hyacinth—Hyacinthus Orientalis

Jasmine—Jasminium Officinalis

Linden Blossom—Tilia Cordata

Narcissus—Narcissus Poeticus

Oakmoss—Evernia Prunastri

Osmanthus—Osmanthus Fragrans

Rose Abs Bulgaria—Rosa Centifolia

Rose Abs Morocco—Rosa Centifolia

Tonka Bean—Dipteryx Odorata

Tuberose—Polianthus Tuberosa

Vanilla—Vanilla Planifolia

Violet Leaf—Viola Odorata

Each of the essential oils has certain properties and other characteristics that make it advantageous for certain treatments. An example of a chart showing information concerning, a representative oil is Table B.

### EXAMPLE

A customer desirous of obtaining an essential formulation has personality and preference information A1 is entered into the system. Based on the information provided personality responses are calculated to determine a personality value A2. From the personality value one or more essential oils may be excluded from Essential Oil Universe or Modified Essential Oil Universe, in view of certain conditions in the personality value and/or by name C1. Exclusionary conditions C2 are obtained from input of consumer information. If so indicated, all essential oils, from Essential Oil Universe or Modified Essential Oil Universe that represent adversity to that condition are excluded from the determination C2a. If no oils or additional oils are to be excluded, the process proceeds, C2b. The exclusionary process may also include a process Z, where oils may be excluded (suspended) from the modified essential oil universe, for the active formulation only. The identity of any additional exclusionary oil names are obtained directly from input Z by name. If the presence of the oil is indicated, then any oil with that name from Essential Oil Universe or Modified Essential Oil Universe is excluded, Z1 forming the active universe, A3. The remaining essential oils make up the Active Essential Oil Universe, and this universe is filtered A3 for all oils for the given Personality Value. A Personality Sub-Set A4 is created from step A3, and contains only oils associated with the given Personality Value.

Based on the input a primary preference A5 is determined from input. The Personality Sub-Set A4 is searched to satisfy the primary preference according to the ranking and an oil is selected A6. This oil is added to formulation and used to continue the process. The Essential Oil Personality Sub-Set A7 is searched for all oils that are related to the primary oil selected in A6, to create the Primary Essential Oil Family Set. A secondary preference A8 is also determined from input. The Primary Essential Oil Family Set is searched A7 to satisfy the secondary preference according to ranking and a second essential oil is selected A8a.

The second selected oil is tested for exactness in name E1 and fragrant “note” E2 to other essential oils that have previously been selected and confirmed. If the second essential oil is not the same, that oil is confirmed A9, and placed in formulation. If the oil is the same E3, that oil is removed from Primary Essential Oil Family Set A7 and then the process repeats itself at starting at A8, for all subsequent preferences determined, and oil(s) selected. In the process of the present invention the preferred output is determined from the user input.

In some situations the user seeks to have the formulation provide some of the benefits of the Chakra oil process D1. In these instances, a Chakra value is calculated from input D2. The Chakra universe is searched D3 for a value. A Chakra oil is selected D4. The Active Essential Oil Universe is searched to confirm active status of the Chakra oil so selected D5. If the Chakra oil is not active D6a, alternate chakra oil is selected. If so the Chakra essential oil is active the selection D6b is confirmed. All oils selected are formatted A11 for desired output. The formulation determined is displayed A12.

From time to time the formulation may be recalculated. If so the process goes to step A1 where information input is still active A13a. The formulation may be saved to a client archive A13a. The formulation may also be printed A13b. The process ends A14.

In some instances, it may be necessary or desired to modify the essential oil universe in a way that is semi-permanent in nature. If so one or more oils in the essential oil universe may be selected for exclusion from the process B1, for example by un-checking its check box in an oil inventory feature The unchecked oils will not be used in the above process until check box is checked and therefore activated.

I claim:

1. A method for formulating an essential oil based composition comprising
performing an analysis of an individual;
calculating a value from the analysis;
determining from the value whether one or more essential oils may be excluded from an essential oil universe comprising a plurality of essential oils to form an active essential oil universe;
generating a sub-set that contains only oils associated with the given value;
selecting a primary essential oil from the sub-set based on the analysis; and generating a primary essential oil family set;
selecting a second essential oil and any subsequent oils from the primary essential oil family set, based on the analysis;
said steps for selecting the second essential oil, being repeated for any additional essential oils to be selected.

2. The method according to claim 1 wherein the analysis is a personality analysis.

3. The method according to claim 1 wherein the analysis is a preference analysis.

4. The method according to claim 1 wherein the analysis is a preference and personality analysis.

5. The method according to claim 4 wherein a personality value is calculated from the personality and preference analysis

6. The method according to claim 5 wherein the personality value generates a sub-set that contains only oils associated with the given personality value.

7. The method according to claim 1 wherein a second, or subsequent essential oil(s) is (are) compared to the primary essential oil for exactness in name, if the second or subsequent essential oil(s) is (are) not the same as the primary essential oil, the second essential oil is confirmed and placed in a formulation;
if the oil is the same, that oil is removed from the sub-set and then the process repeats itself to select a second or subsequent essential oil(s).

8. The method according to claim 1 wherein a second, or subsequent essential oil(s) is (are) compared to the primary essential oil for exactness in fragrant note, if the second or subsequent essential oil(s) is (are) not the same as the primary essential oil, the second essential oil is confirmed and placed in a formulation;
if the oil is the same, that oil is removed from the sub-set and then the process repeats itself to select a second or subsequent essential oil(s).

9. The method according to claim 7 wherein the comparison is further based on a fragrant note of an oil.

10. The method according to claim 1 wherein one or more essential oils are excluded from the active universe based on certain exclusionary conditions as determined by personality/preference analysis.

11. The method according to claim 1 further comprising the step of selecting a chakra oil based on said analysis and adding said oil to the composition.

12. The method according to claim 1, wherein user input can narrow the active essential oil universe.

13. The method according to claim 1 wherein user input can narrow the active essential oil universe for only the current/active formulation.

14. A system for formulating an essential oil based composition comprising
a means for performing an analysis of an individual;
a means for calculating a value from the analysis;
a means for determining from the value whether one or more essential oils may be excluded from an essential oil universe comprising a plurality of essential oils to form an active essential oil universe;
a means for generating a sub-set that contains only oils associated with the given value;
a means for selecting a primary essential oil from the sub-set based on the analysis; and generating a primary essential oil family set;
a means for selecting a second essential oil and any subsequent oils from the primary essential oil family set, based on the analysis.

15. An apparatus for formulating an essential oil based composition comprising
a means for performing an analysis of an individual;
a means for calculating a value from the analysis;
a means for determining from the value whether one or more essential oils may be excluded from an essential oil universe comprising a plurality of essential oils to form an active essential oil universe;
a means for generating a sub-set that contains only oils associated with the given value;
a means for selecting a primary essential oil from the sub-set based on the analysis; and
generating a primary essential oil family set;
a means for selecting a second essential oil and any subsequent oils from the primary essential oil family set, based on the analysis.

16. The method according to claim 1 wherein formulation is used as a fragrance.

17. The method according to claim 1 wherein the formulation is used as a massage oil.

18. The method according to claim 1 wherein the formulation is used as a lotion.

19. The method according to claim 1 wherein the formulation is used as a salve

20. The method according to claim 1 wherein the formulation is used as an unguent.

21. The method according to claim 1 wherein the formulation is included in a cosmetic formulation.

22. The method according to claim 1 wherein the formulation is included in a bath oil.

23. The method according to claim 1 wherein the formulation is included in a body oil.

24. The method according to claim 1 wherein the formulation is included in a face cream.

25. The method according to claim 1 wherein the formulation is included in a hand lotion.

26. An essential oil based composition comprising
a primary essential oil determined by performing an analysis of an individual, calculating a value from the analysis, determining from the value whether one or more essential oils may be excluded from an essential oil universe comprising a plurality of essential oils to form an active essential oil universe, generating a sub-set that contains only oils associated with the given value, selecting a primary essential oil from the sub-set based on the analysis; and generating a primary essential oil family set, selecting a second essential oil and any subsequent oils from the primary essential oil family set, based on the analysis.

27. The composition according to claim 26 used in a fragrance.

28. The composition according to claim 26 used in a massage oil.

29. The composition according to claim 26 used in a lotion.

30. The composition according to claim 26 used in a salve

31. The composition according to claim 26 used in an unguent.

32. The composition according to claim 26 being present in a cosmetic formulation.

33. The composition according to claim 26 being present in a bath oil.

23. The composition according to claim 26 being present in a body oil.

34. The composition according to claim 26 being present in a face cream.

35. The composition according to claim 26 being present in a hand lotion.
